(19) United States
(12) Patent Application Publication
(10) Pub. No.: US 2022/0164256 A1
(43) Pub. Date: May 26, 2022

(54) CAPTURING AND RESTORING DISPLAY CONTENT FROM MULTIPLE DISPLAY DEVICES

(71) Applicant: FIVE RIVERS TECHNOLOGIES (PVT.) LTD, Lahore (PK)

(72) Inventors: SYEDA MAHE ZEHRA, LAHORE (PK); SYED SAAD HUSSAIN, LAHORE (PK)

(21) Appl. No.: 17/532,642

(22) Filed: Nov. 22, 2021

Related U.S. Application Data
(60) Provisional application No. 63/116,896, filed on Nov. 22, 2020.

(51) Int. Cl. G06F 11/14; G06F 3/14; G09G 5/00

(52) U.S. Cl. CPC G06F 11/1446; G06F 11/1438; G09G 5/006; G06F 3/1446

(57) ABSTRACT

Capturing and restoring display content from multiple display devices, including: receiving a request to create a profile associated with one or more display devices; capturing, from the one or more display devices, information describing windows displayed on each of the display devices; associating the captured information with the profile; receiving a request to restore display content associated with a particular profile; and creating, on the one or more display devices, one or more windows using the information describing windows displayed on each of the display devices.

### CROSS-REFERENCE TO RELATED APPLICATION

This is a non-provisional application for patent entitled to a filing date and claiming the benefit of earlier-filed U.S. Provisional Patent Application No. 63/116,896, filed Nov. 22, 2020, herein incorporated by reference in its entirety.

### BACKGROUND

### Field of the Disclosure

The field of the disclosure is data processing, or, more specifically, methods, apparatus, and products for capturing and restoring display content from multiple display devices.

### SUMMARY

Methods, apparatuses, and products for capturing and restoring display content from multiple display devices, including: receiving a request to create a profile associated with one or more display devices; capturing, from the one or more display devices, information describing windows displayed on each of the display devices; associating the captured information with the profile; receiving a request to restore display content associated with a particular profile; and creating, on the one or more display devices, one or more windows using the information describing windows displayed on each of the display devices.

The foregoing and other objects, features and advantages of the disclosure will be apparent from the following more particular descriptions of example embodiments of the disclosure as illustrated in the accompanying drawings wherein like reference numbers generally represent like parts of example embodiments of the disclosure.

### BRIEF DESCRIPTION OF THE DRAWINGS

FIG. 1 sets forth a block diagram of automated computing machinery comprising an example computer configured for capturing and restoring display content from multiple display devices according to some embodiments of the present disclosure.

### DETAILED DESCRIPTION

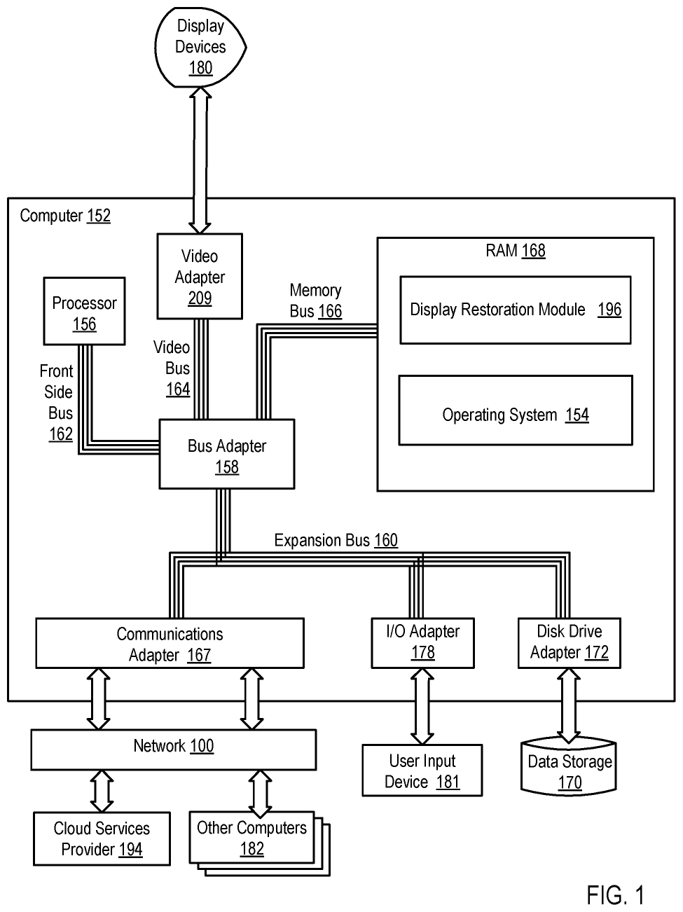

Example methods, apparatus, and products for capturing and restoring display content from multiple display devices in accordance with the present disclosure are described with reference to the accompanying drawings, beginning with FIG. 1. FIG. 1 sets forth a network diagram of a system configured for capturing and restoring display content from multiple display devices according to embodiments of the present disclosure. Capturing and restoring display content from multiple display devices in accordance with the present disclosure is generally implemented with computers, that is, with automated computing machinery. For further explanation, therefore, FIG. 1 sets forth a block diagram of automated computing machinery comprising an example computer (152) configured for capturing and restoring display content from multiple display devices according to some embodiments of the present disclosure.

The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152). In the example depicted in FIG. 1, an operating system (154) is stored in RAM (168) of the computer (152). Operating systems useful in computers configured for capturing and restoring display content from multiple display devices according to embodiments of the present disclosure include UNIX™, Linux™, Microsoft Windows™, AIX™, IBM's i5/OS™, Apple macOS™, and others as will occur to those of skill in the art. The operating system (154) and the display restoration module (196) in the example of FIG. 1 are shown in RAM (168), but many components of such software typically are stored in non-volatile memory also, such as, for example, on a disk drive (170).

Also stored in RAM (168) is a display restoration module (196), a module of computer program instructions for capturing and restoring display content from multiple display devices in accordance with the present disclosure. The display restoration module (196) may, when executed, cause the computer (152) to carry out the steps of: receiving a request to create a profile associated with one or more display devices; capturing, from the one or more display devices, information describing windows displayed on each of the display devices; associating the captured information with the profile; receiving a request to restore display content associated with a particular profile; and creating, on the one or more display devices, one or more windows using the information describing windows displayed on each of the display devices. Readers will appreciate that the display restoration module (196) may also, when executed, cause the computer (152) to carry out the steps described below, including variations thereof.

The display restoration module (196) depicted in FIG. 1 may be configured for retaining and restoring the configuration of currently displayed windows across multiple monitors (e.g., the one or more display devices (180) depicted in FIG. 1). The display restoration module (196) may be running, for example, as a systray utility that is executing on a computing device that controls the content being displayed on a particular monitor. For example, the display restoration module (196) may be executing on a desktop computer that has multiple monitors attached to the desktop computer. In such an example, the configuration of currently displayed windows, across multiple monitors, may be associated with a profile that may subsequently be used to restore the state of the monitors as was captured by a particular profile.

As an example, if a user has four monitors and has a web browser displayed on monitor 1, a text editing application displayed on monitor 2, a spreadsheet application displayed on monitor 3, and a presentation program (e.g., Microsoft™ PowerPoint™) displayed on monitor 4, the user may utilize the display restoration module (196) to capture this configuration of content being displayed on each of the four monitors and associate that configuration of content being displayed on each of the four monitors with a particular profile. For example, the display restoration module (196) may be configured to display a “create new profile” menu item (e.g., the user can click the systray icon associated with the display restoration module (196), which would provide the user with simple list menu) that the user can utilize to create a new profile that will be associated with the configuration of content being displayed on each of the four monitors.

Consider the example described above in which a user has four monitors and has a web browser displayed on monitor 1, a text editing application displayed on monitor 2, a spreadsheet application displayed on monitor 3, and a presentation program (e.g., Microsoft™ PowerPoint™) displayed on monitor 4. Assume in this example that the user creates a new profile that the user names as the “work” profile. In such an example, even after the user has closed all open windows on the 4 monitors, or opened other windows, the user can restore the content that was being displayed on the 4 monitors by utilizing a “restore” feature (which will be described in greater detail below) that is offered by the display restoration module (196) and selecting the “work” profile as the profile to restore.

In some embodiments, all saved profiles would appear as a multi-level list menu that can be displayed by the display restoration module (196). For example, a primary systray menu may have a “restore profile” menu item, and when the mouse hovers over this “restore profile” menu item, the menu may further expand into a second list that is used to display the names of all profiles, i.e. “work,” “digital audio editing,” “homework,” or any other names the user has associated with a particular profile. In some embodiments, clicking on any of these profiles will restore associated monitors to the configuration that the associated monitors were in at the time that the profile was created.

In some embodiments, if a user attempts to restore windows associated with programs that are not currently opened, then those applications will be launched and moved to the previously saved coordinates. For example, if the user attempts to restore the “work” profile described above in which a web browser is displayed on monitor 1 but the web browser application is not currently running, an instance of the web browser application may be opened and subsequently placed on monitor 1 with the same coordinates that it was located when the “work” profile was created. If a user attempts to restore windows associated with programs that are currently opened, however, then the display restoration module (196) will simply relocate the window to the appropriate location. For example, if the user attempts to restore the “work” profile described above in which a web browser is displayed on monitor 1 and the web browser application is currently running but not displayed on monitor 1 at the appropriate coordinates, the web browser window will simply be moved to monitor 1 with the same coordinates that it was located when the “work” profile was created.

Readers will appreciate that if extra applications or windows are open that are not part of the saved configuration, such windows may be treated in a variety of ways. For example, if the user attempts to restore the “work” profile described above but a paintbrush application that was not included in the “work” profile is currently being displayed on monitor 3, the paintbrush application may be treated in a variety of ways. In one embodiment, the default setting may be to “minimize” the paintbrush application without actually shutting the paintbrush application down. In other embodiments, the application may be shut down, a user may be prompted to select whether to shutdown or minimize the application, and so on. In accordance with embodiments described herein, defaults may be configurable by a user when installing the display restoration module (196) or at some other time.

Browser tabs and multiple instances of windows of the same application may require special handling. Consider an example in which two web browser windows are open, where the first web browser window includes 5 open tabs and the second web browser window includes 6 open tabs. In accordance with embodiments of the present disclosure, at the time that the profile is saved, the tab details will also be saved. As such, when restoring the placement of such windows, the number of tab matches may be used as the criteria to decide where to move each browser window. For example, if the first web browser window with 5 open tabs was being displayed on monitor 1 and the second web browser window with 6 open tabs was being displayed on monitor 2, the number of open tabs may be used to place the browser windows (e.g., browser window with 5 open tabs will be displayed on monitor 1 and browser window with 6 open tabs will be displayed on monitor 2). In a situation where each browser has the same number of tabs open, the actual content of those tabs can be used when determining the placement of each browser. The display restoration module (196) may handle multiple instances of applications in similar manner. For example, if multiple instances of a text editor were open, all information related to the application's state (e.g., title of the document, full path to the executable) may be retained in an associated profile such that some aspect of the application's state (e.g., the title of a particular window) could be used to determine when to restore each instance of the application when restoring the windows associated with a particular profile.

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers configured for [preamble] according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to one or more display devices (180) such as a display screens or computer monitors. Video adapter (209) is connected to processor (156) through a high speed video bus (164), bus adapter (158), and the front side bus (162), which is also a high speed bus.

The example computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for capturing and restoring display content from multiple display devices according to embodiments of the present disclosure include modems for wired dial-up communications, Ethernet (IEEE 802.3) adapters for wired data communications, and 802.11 adapters for wireless data communications.

In the example depicted in FIG. 1, the computer (152) is also connected for data communications to other computers (182) as well as a cloud services provider (194) via the data communications network (100). Readers will appreciate that although the example depicted in FIG. 1 relates to an embodiments where the display restoration module (196) is depicted as residing within RAM (156) of the computer (152), in other embodiments the functionality of the display restoration module (196) may be delivered as a software-as-a-service (‘SaaS’) offering that is delivered by the cloud services provider (194). In such an example, each profile and its associated data may therefore be stored by the cloud services provider (194) or the cloud services provider (194) may make use of such information if stored locally on the computer (152) itself

Although the examples described above relate to embodiments where the content of multiple display devices are captured and restored, in other embodiments similar concepts may be applied to a single display device with multiple logical (or even physical) sections. For example, a single display device whose display area is logically divided into four quadrants may have display information captured and restored in a similar manner as described above with reference to an embodiment where four distinct display devices—rather than 4 logical display areas—were utilized.

In addition, although embodiments are described above in which the multiple display devices are connected to a single computing device, in other embodiments the multiple display devices may be connected to multiple computing devices that carry out the steps described above using data communications between the computing devices to facilitate similar functionality. Furthermore, one or more of the computing devices that the one or more display devices are connected to may take forms other than a traditional computing device. That is, while the computer (152) described above could be embodied as a desktop computing, a laptop computer, a tablet computer, a smartphone, a television, and so on, the computer (152) could also be embodied as virtualized computer hardware such as a virtual machine.

Example embodiments of the present disclosure are described largely in the context of a fully functional computer system for capturing and restoring display content from multiple display devices. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the example embodiments described in this specification are oriented to software installed and executing on computer hardware, nevertheless, alternative embodiments implemented as firmware or as hardware are well within the scope of the present disclosure.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of capturing and restoring display content from multiple display devices, the method comprising:
receiving a request to create a profile associated with one or more display devices;
capturing, from the one or more display devices, information describing windows displayed on each of the display devices;
associating the captured information with the profile;
receiving a request to restore display content associated with a particular profile; and
creating, on the one or more display devices, one or more windows using the information describing windows displayed on each of the display devices.

2. The method of claim 1 wherein the one or more display devices include at least two display devices.

3. The method of claim 1 wherein the one or more display devices include at least two logical portions of a single display device.

4. The method of claim 1 wherein at least one of the windows includes a plurality of tabs.

5. An apparatus for capturing and restoring display content from multiple display devices, the apparatus comprising a computer processor, a computer memory operatively coupled to the computer processor, the computer memory having disposed within it computer program instructions that, when executed by the computer processor, cause the apparatus to carry out the steps of:
receiving a request to create a profile associated with one or more display devices;
capturing, from the one or more display devices, information describing windows displayed on each of the display devices;
associating the captured information with the profile;
receiving a request to restore display content associated with a particular profile; and
creating, on the one or more display devices, one or more windows using the information describing windows displayed on each of the display devices.

6. The apparatus of claim 5 wherein the one or more display devices include at least two display devices.

7. The apparatus of claim 5 wherein the one or more display devices include at least two logical portions of a single display device.

8. The apparatus of claim 5 wherein at least one of the windows includes a plurality of tabs.

9. A computer program product for capturing and restoring display content from multiple display devices, the computer program product disposed upon a computer readable medium, the computer program product comprising computer program instructions that, when executed, cause a computer to carry out the steps of:
receiving a request to create a profile associated with one or more display devices;
capturing, from the one or more display devices, information describing windows displayed on each of the display devices;
associating the captured information with the profile;
receiving a request to restore display content associated with a particular profile; and
creating, on the one or more display devices, one or more windows using the information describing windows displayed on each of the display devices.

10. The computer program product of claim 9 wherein the one or more display devices include at least two display devices.

11. The computer program product of claim 9 wherein the one or more display devices include at least two logical portions of a single display device.

12. The computer program product of claim 9 wherein at least one of the windows includes a plurality of tabs.
